(19) United States
(12) Patent Application Publication
(10) Pub. No.: US 2004/0059641 A1
(43) Pub. Date: Mar. 25, 2004

(54) System and method for creating user selected customized digital data compilations

(76) Inventors: Lucas Brown, Elma, WA (US); Lee Brown, Elma, WA (US)

Correspondence Address: BLACK LOWE & GRAHAM, PLLC, 701 FIFTH AVENUE, SUITE 4800, SEATTLE, WA, 98104, US

(21) Appl. No.: 10/606,650

(22) Filed: Jun. 25, 2003

Related U.S. Application Data
(60) Provisional application No. 60/391,560, filed on Jun. 25, 2002.

(51) Int. Cl. G06F 17/60

(52) U.S. Cl. 705/26; 709/217; 709/246

(57) ABSTRACT

The present invention provides for the creation of customized data compilation utilizing a variety of media types and with proper royalty payments. These customized data compilations are created at distributed locations using central database or distributed databases, a local workstation, and a high-speed media specific recording device.

### PRIORITY CLAIM

This application claims the benefit of U.S. Provisional Application Serial No. 60/391,560 filed Jun. 25, 2002.

### FIELD OF THE INVENTION

This invention relates generally to computer systems and, more specifically, to a computer system for creating user selected customized digital data compilations.

### BACKGROUND OF THE INVENTION

There currently is an “underground” market for customized compact discs (“CDs”) including custom music CDs. These custom CDs are made, for example, by obtaining copies of songs in digital format, by either downloading the desired songs from the Internet or copying or “ripping” the songs onto a personal computing system from borrowed CDs, and then recording or “burning” the songs onto blank CDs using a CD-R drive. Custom music CDs are assembled in minutes, and represent lost revenue to the record companies, since unauthorized copies of property are made that would otherwise be subject to royalties.

### SUMMARY OF THE INVENTION

The system described herein provides for the creation of customized data compilation utilizing a variety of media types (e.g., CD, DVD, DAT, Mini-disc, MPEG 3 Digital file, etc.), with proper royalty payments, and thus facilitates greatly expanding a newly emerging market for customized audio products. These customized data compilations are typically created at distributed locations (such as record stores) using a central database or distributed databases, a local workstation and a high-speed media specific recording device, such as a CD-Recorder, DVD-Recorder, DAT recorder, Mini-disc recorder, etc.

It should be noted that the audio information is not necessarily constrained to music, and can encompass additional areas suitable for customization, including currently existing markets for personal self-improvement, business lectures, and other forms of audio data marketed to the public. Additionally, still-video or visual text information may also be associated with the music audio data, including textual data on recording artists, still photos of the artists and graphics for custom label or other media production. For other custom audio products, such as customized business lectures, scientific material, and integration of excerpts from books and/or speeches, still-visual data (such as text, graphs, drawings and/or photos) may be included for off-line publication and use while listening to the audio information, or included in a multi-media, integrated media type, such as a CD-ROM, or DVD-ROM playable, for example, on current personal computer systems.

### BRIEF DESCRIPTION OF THE DRAWINGS

The preferred and alternative embodiments of the present invention are described in detail below with reference to the following drawings.

FIG. 1 is a block diagram of a system for creating user selected customized digital data compilations in accordance with the present invention;

FIG. 2 is a block diagram of a representative portion of the Internet;

FIG. 3 is a block diagram of an illustrative architecture for a workstation computer system in accordance with the present invention;

FIG. 4 is a block diagram of an illustrative architecture for a remote central server utilized to transmit data files to the workstation computer in accordance with the present invention;

FIG. 5 is a flow diagram of a routine implemented by the workstation computer for creating a customized data compilation in accordance with the present invention;

FIGS. 6A and 6B are a flow diagram of a subroutine implemented by the workstation computer for procuring the selected data files for creating a customized data compilation in accordance with the present invention;

FIG. 7 is a flow diagram of a sub routine implemented by the workstation computer for publishing a customized data compilation in accordance with the present invention; and

FIG. 8 is a flow diagram of a sub routine implemented by the workstation computer for selecting billing information from the selected data files in accordance with the present invention.

### DETAILED DESCRIPTION OF THE PREFERRED EMBODIMENT

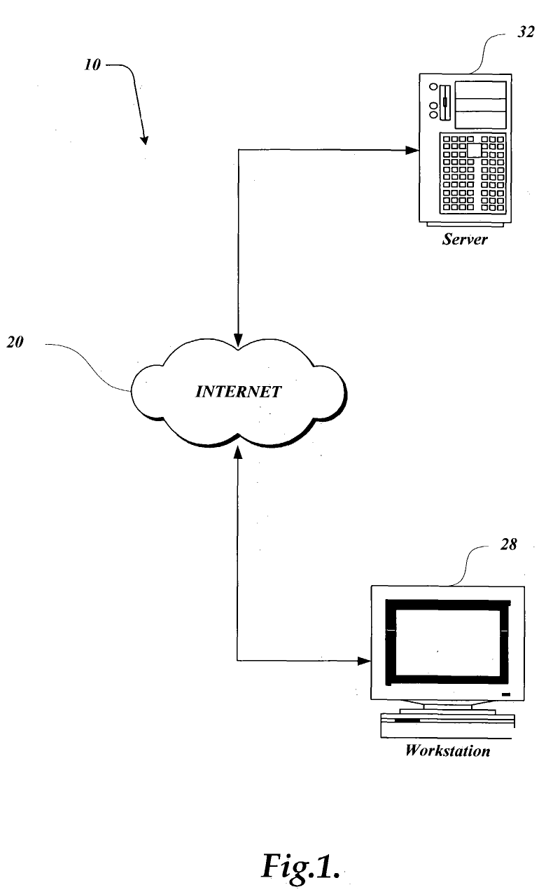

In accordance with the present invention, an illustrative embodiment of a digital customized system for creating user-selected customized digital data compilations is shown in FIG. 1. Generally described, the system 10 allows a user to select data files, such as audio files, from a plurality of data files stored on a workstation computer 28 located at a point of sale location, such as a record store, for creating customized digital data compilations. The workstation computer 28 is connected via a communications network 20 to a remote server(s) 32, which stores an additional mass quantity of data files for selection by the user.

In operation, a user wishing to create a custom compilation selects one or more data files from a list of data files on the workstation computer 28. The workstation computer 28 obtains the user selected data files by first searching the memory of the workstation computer 28. If one or more of the user selected data files is not located on the workstation computer 28, the workstation computer communicates with one or more remote servers 32 to search for the selected data files. If the selected data file is located on the remote server 32, the remote server 32 transmits a copy of the data file over the communications network 20 to the workstation computer 28 to be added to the user's list of selected data files. Once all of the data files are located and added to the user's list, the data files are published as a customized compilation containing all of the selected data files in any one of a plurality of media types, such as CD, DAT, DVD, miniature disk, flash memory, or memory sticks, by utilizing a corresponding output device. In addition to the selected data files, associated data, such as royalty billing information, may be assembled by either the workstation or the remote server.

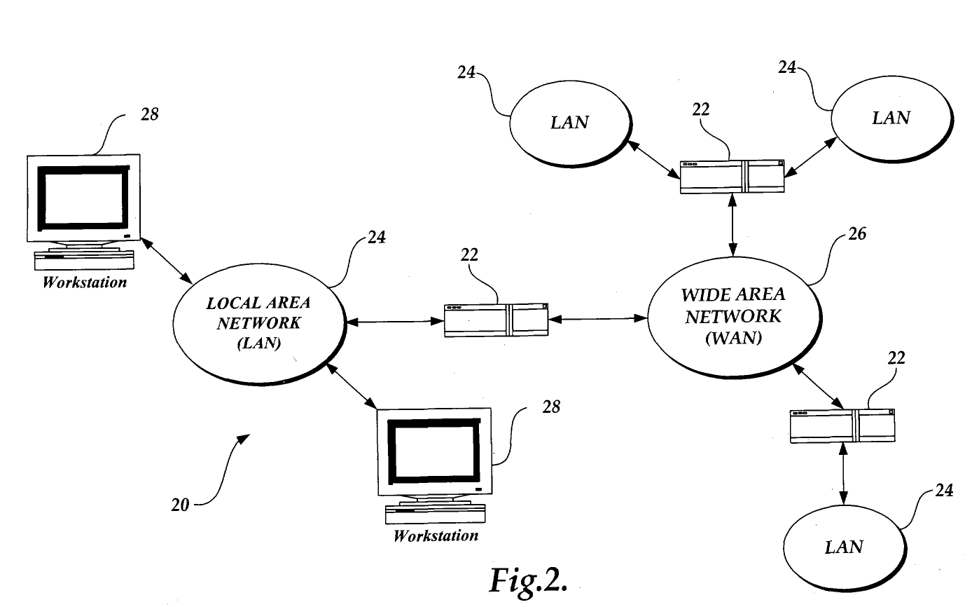

Referring now to FIG. 2, an illustrative operating environment for an embodiment of the present invention will be described. Aspects of the present invention are implemented as an executable software component located on a workstation computer, accessible via the Internet. As is well known to those skilled in the art, the term “Internet” refers to the, collection of networks and routers that use the Transmission Control Protocol/Internet Protocol (“TCP/IP”) to communicate with one another. A representative section of the Internet 20 is shown in FIG. 2, in which a plurality of local area networks (“LANs”) 24 and a wide area network (“WAN”) 26 are interconnected by routers 22. The routers 22 are special purpose computers used to interface one LAN or WAN to another. Communication links within the LANs may be twisted wire pair, or coaxial cable, while communication links between networks may utilize 56 Kbps analog telephone lines, 1 Mbps digital T-1 lines, 45 Mbps T-3 lines or other communications links known to those skilled in the art. Furthermore, a consumer computer 28 and other related electronic devices can be remotely connected to either the LANs 24 or the WAN 26 via a modem and temporary telephone or wireless link. It will be appreciated that the Internet 20 comprises a vast number of such interconnected networks, computers, and routers and that only a small, representative section of the Internet 20 is shown in FIG. 2.

A consumer or other remote user may retrieve hypertext documents from the World Wide Web (“WWW”) via a WWW application, which can include WWW browser application programs. A WWW browser, such as Netscape's NAVIGATOR® or Microsoft's Internet Explorer, is a software application program for providing a graphical user interface to the WWW. Upon request from the user via the WWW browser, the WWW browser accesses and retrieves the desired hypertext document from the appropriate WWW server using the URL for the document and a protocol known as HyperText Transfer Protocol (“HTTP”). HTTP is a higher-level protocol than TCP/IP and is designed specifically for the requirements of the WWW. It is used on top of TCP/IP to transfer hypertext documents between servers and clients. The WWW browser may also retrieve application programs from the WWW server, such as JAVA applets, for execution on the consumer computer 28. Further, a WWW browser may retrieve data files using other protocols known in the art, such as File Transfer Protocol (“FTP”). While the present invention as been described herein utilizes the Internet as one type of communications network, a private network suitably configured as known in the art may be used, if desired.

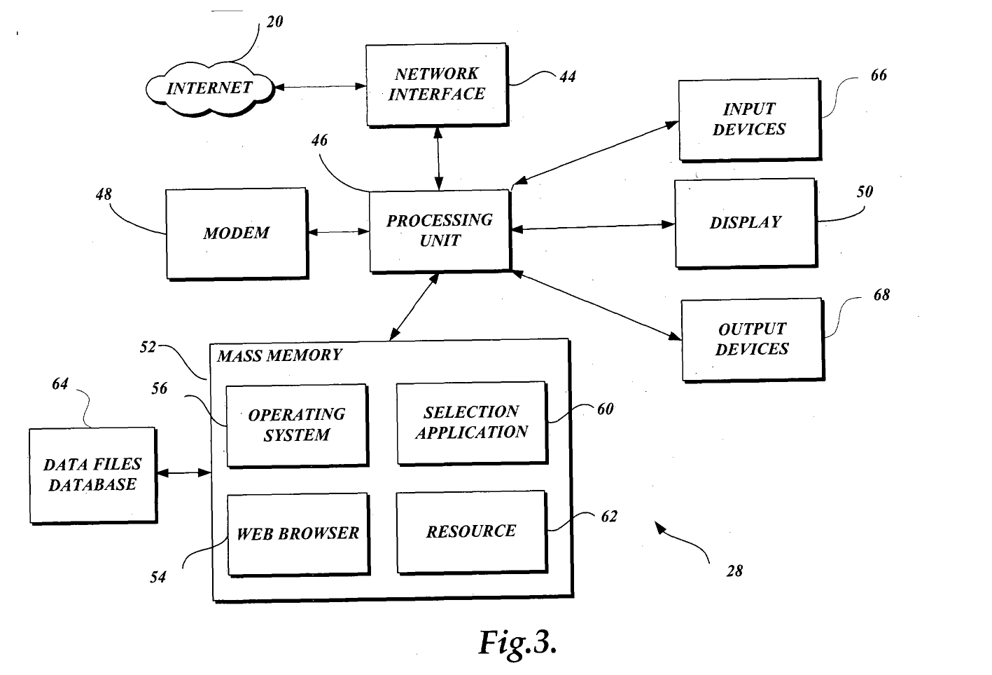

Referring back to FIG. 1, an actual embodiment of the present invention will now be described. A workstation computer 28 is connected to the Internet 20 through a modem, private network, virtual network, or other type of connection. Once connected to the Internet 20, a user of the workstation computer 28 may utilize a WWW browser to retrieve data files from WWW sites, such as a WWW site provided by the remote server 32. As is known to those skilled in the art, the workstation computer 28 may comprise, for example, a workstation, a computer kiosk, or a general purpose computer, all capable of executing a WWW application or WWW browser. The computer 28 may also comprise another type of computing device such as a palm-top computer, a cell phone, personal digital assistant, and the like. Computer 28 is described in greater detail below with respect to FIG. 3.

Turning now to FIG. 3, an illustrative architecture for the workstation computer 28 will now be described. The workstation computer 28 includes many more components than those shown in FIG. 3. However, it is not necessary that all of these generally conventional components be shown in order to disclose an illustrative embodiment for practicing the present invention.

As shown in FIG. 3, the workstation computer 28 includes a network interface 44 for connecting directly to a LAN or a WAN, or for connecting remotely to a LAN or WAN. Those of ordinary skill in the art will appreciate that the network interface 44 includes the necessary circuitry for such a connection, and is also constructed for use with the TCP/IP protocol, the particular network configuration of the LAN or WAN it is connecting to, and a particular type of coupling medium. The workstation computer 28 may also be equipped with a modem 48 for connecting to the Internet through a point to point protocol (“PPP”) connection or a SLIP connection as known to those skilled in the art.

The workstation computer 28 also includes a processing unit 46, a display 50, and a memory 52. The memory 52 generally comprises a random access memory (“RAM”), a read-only memory (“ROM”) and a permanent mass storage device, such as a disk drive, optical drive, or the like. The memory 52 stores an operating system 56 for controlling the operation of the workstation computer 28. In one actual embodiment of the invention, the operating system 56 provides a graphical operating environment, such as Microsoft Corporation's WINDOWS® graphical operating system in which activated application programs are represented as one or more graphical application windows with a display visible to the user.

The memory 52 also includes a WWW browser 54, such as Netscape's NAVIGATOR® or Microsoft's Internet Explorer browser, or other WWW applications for accessing the WWW. It will be appreciated that these components may be stored on a computer-readable medium and loaded into the memory 52 of the workstation computer 28 using a drive mechanism associated with the computer-readable medium, such as a floppy, CD-ROM or DVD-ROM drive. The memory 52 may also include a data compilation creation application 60. As will be described in greater detail below, the data compilation creation application 60 is capable of creating a published compilation of user selected digital data files. Further, the memory 52 may include data resource files 62, preferably contained in a searchable database. Optionally, an external database 64 may be connected to the memory 52 and accessible by the processing unit 46.

The memory 52, network interface 44, display 50, and modem 48 are all connected to the processing unit 46 via one or more buses. Workstation computer 28 may also include various input devices 66 such as pointing devices, keyboards, or light pens, which are connected to the processing unit 46 via one or more buses. As would be generally understood, other peripherals may also be connected to the processing unit in a similar manner. The workstation computer 28 further includes output or publishing devices 68, for example, CD-R drives, DVD-R drives, miniature disk drives, and printers, which are also connected to the processing unit 46 via one or more buses. Other output devices 62 of the workstation computer 28 may include interface devices, such as USB ports, or devices such as drive mechanisms for transferring the selected data files onto a storage medium, such as flash memory, memory sticks, and the like.

Additionally, it will be appreciated that the workstation computer 28 may include the necessary components (not shown) to provide wireless data transmission over any known protocol, such as 802.11, Bluetooth, infra-red, to name a few, to a wireless digital device, such as a palm-top computer, a cell phone, personal digital assistant, and the like. It will be appreciated that the data may be transmitted in any known uncompressed format or compressed format, such as MPEG 3.

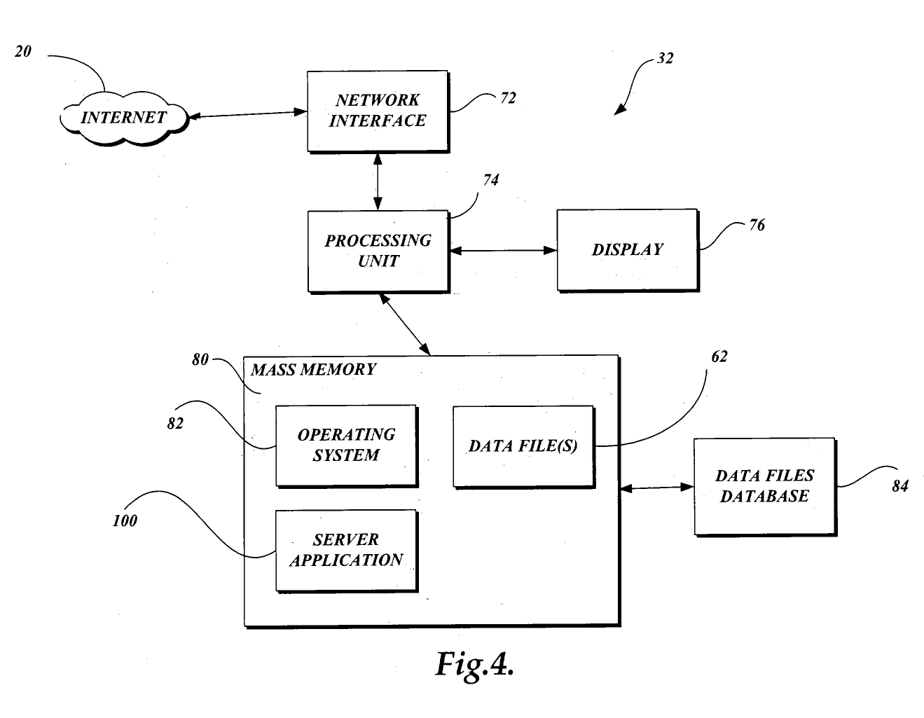

As mentioned briefly above, a remote central server computer 32 is also connected to the Internet 20. The central server 32 comprises a general purpose server computer and is described in more detail below with reference to FIG. 4. The central server 32 stores additional data files 62, such as audio, video, text, and graphic files, and receives requests for such data files 62 from the workstation computer 28. The data files 62 may be cataloged in a database, as will be described below, by searchable fields, such as title, artist, publisher (e.g. Sony®, Capital®, Arista®, etc.). Additionally, each data file 62 may be associated with other data, which may include, for example, billing information for the payment of royalties, graphic or photographic files, and text files (e.g. lyrics, biographical data).

Referring now to FIG. 4, an illustrative architecture for a remote central server 32 utilized to provide data files 62 to the workstation computer 28 will be described. The server 32 includes many more components than those shown in FIG. 4. However, it is not necessary that all of these generally conventional components be shown in order to disclose an illustrative embodiment for practicing the present invention. Moreover, although the computer system described in FIG. 4 is described as a server, the function of the server may be implemented by computer systems not generally classified as server-type computer systems. Further, although only one remote central server 32 is depicted in FIG. 1, the central server may be a distributed server that may utilize other servers 32 located elsewhere on the Internet 20 to serve data files 62 to the workstation computer 28.

As shown in FIG. 4, the server 32 includes a network interface 72 for connecting directly to a LAN or a WAN, or for connecting remotely to a LAN or WAN. The network interface 72 includes the necessary circuitry for such a connection, and is also constructed for use with the TCP/IP protocol, the particular network configuration of the LAN or WAN it is connecting to, and a particular type of coupling medium.

The server 32 also includes a processing unit 74, a display 76, and a mass memory 80. The mass memory 80 generally comprises a RAM, a ROM and a permanent mass storage device, such as a hard disk drive, tape drive, optical drive, floppy disk drive, or combination thereof. The memory 80 stores an operating system 82 for controlling the operation of the central server 32. The operating system component 82 may comprise a general-purpose server operating system as is known to those of ordinary skill in the art, such as UNIX, LINUX™, or Microsoft WINDOWS NT®.

The memory 80 includes one or more date files 62 which are to be provided in response to requests from the workstation computer. The data files 62 are preferably contained in a database in memory 80. Optionally, the data files 62 may be retrieved from an external database 84. The memory 80 also includes server application 100 operable to receive such requests from the workstation computer and transmit the selected data files to the workstation computer. These components may be stored on a computer-readable medium and loaded into memory 80 of the server 32 using a drive mechanism associated with the computer-readable medium, such as a floppy, CD-ROM or DVD-ROM drive. The memory 80, network interface 72, and display 76 are all connected to the processing unit 74 via one or more buses. Other peripherals may also be connected to the processing unit in a similar manner.

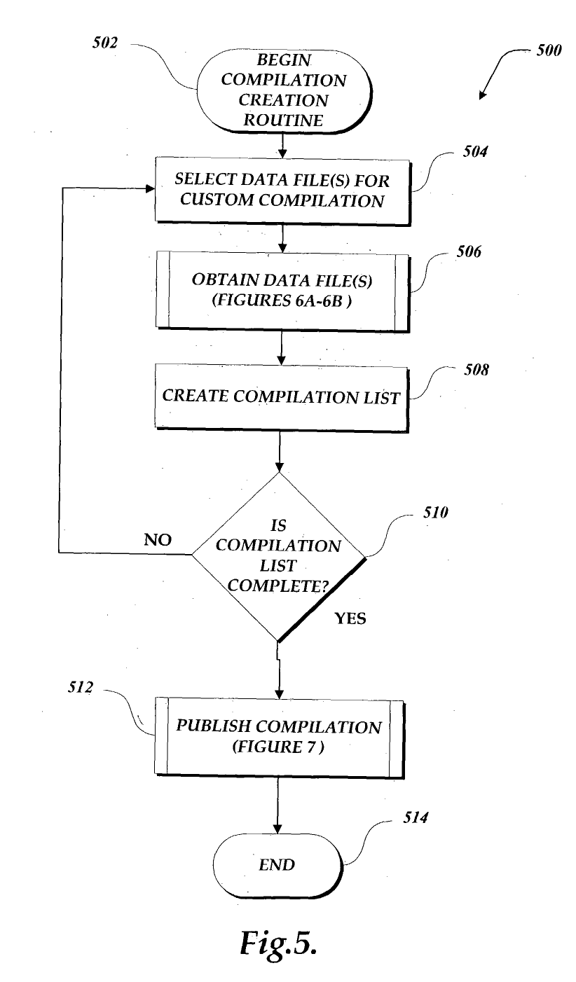

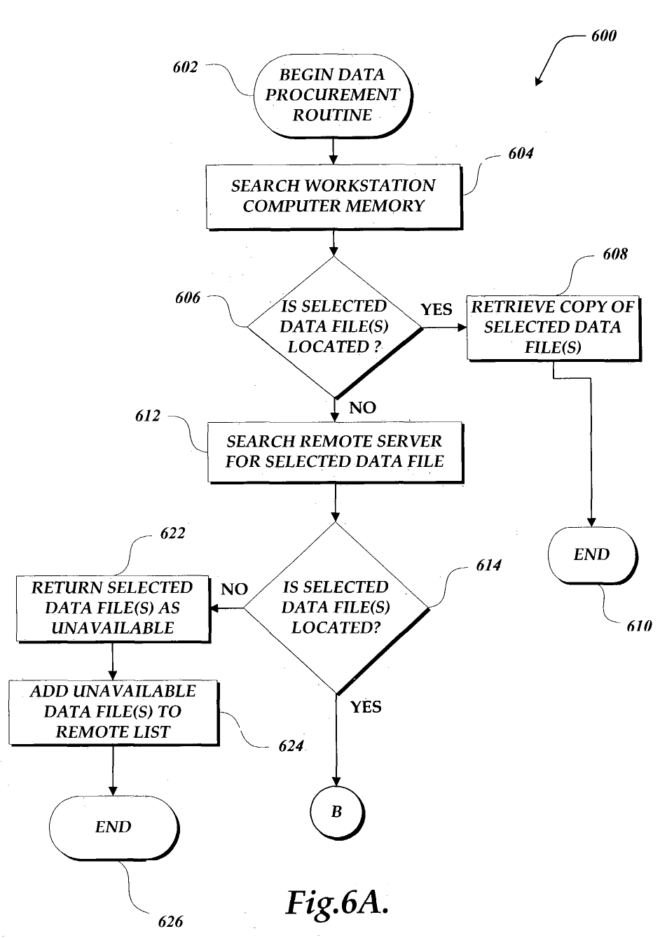

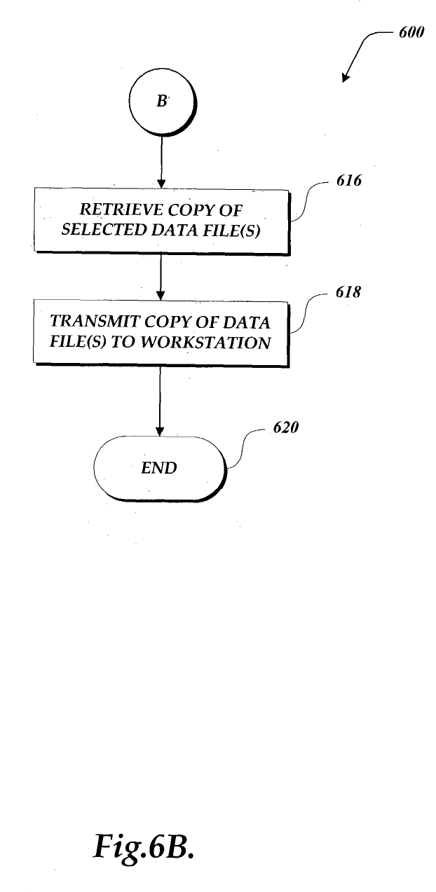

Referring now to FIG. 5, an illustrative routine 500 of the data compilation creation application 60 for creating user customized digital data compilations will now be described. The routine 500 begins at block 502, and proceeds to block 504, where the user operating the workstation is prompted to select one or more data files 62 for creating the user's customized compilation. For example, the user may wish to select songs for a music compilation representing their favorite songs for a specific decade. After the user selects one or more data files 62 at block 504, the routine proceeds to block 506, where the workstation computer 28 executes a routine for obtaining the selected data files 62 for creating the custom compilation. As will be described in more detail below with respect to FIG. 6, the procurement routine retrieves the selected data files 62 from the memory 52 of the workstation, or transmits a request for the data files 62 to the central server 32.

Once a copy of the data files 62 are obtained at block 506, the routine proceeds to block 508, where the copy of each data files 62 is added to a compilation list representative of the custom compilation to be created. Then, at block 510, a test is run to determine if the compilation list is complete. If the compilation list is not complete, the routine 500 returns to block 504, where the user may select another data files 62. If the compilation list is complete, the routine proceeds to block 512, where a publication routine is executed. As will be described in more detail below with reference to FIG. 7, the publication routine allows the user to select what media type the compilation will be published on, formats the selected data files 62 for publication, and sends the data files 62 to the selected output device 68 for publication. After the compilation has been published, for example, written to a Compact Disk (CD) with a Compact Disc Recorder drive mechanism, the routine ends at block 514.

As briefly described above with respect to FIG. 5, FIGS. 6A and 6B depicts the execution of an illustrative procurement routine 600 in greater detail. The routine 600 begins at block 602, and proceeds to block 604, where the memory 52 of the workstation computer 28 is searched first for the one or more selected data files 62. At block 606, a determination is made as to whether the selected data files 62 are located locally in the memory 52 of the workstation computer 28. If the selected data files 62 are located locally on the memory 52 of the workstation computer 28, the routine 600 proceeds to block 608 where the routine 600 retrieves a copy of the selected data files 62 from the memory 52. Once a copy of the selected data files 62 has been retrieved at block 608, the routine 600 ends at block 610.

If the selected data files 62 has not been located locally in the memory 52 of the workstation computer 28, the routine 600 proceeds to block 612, where a search is conducted of the remote server 32 for the, selected data files 62. The routine 600 continues to block 614, where a determination is made as to whether the selected data files are located in the memory 80 of the remote server 28. If so, the routine 600 retrieves a copy of the selected data files 62 from the memory 80 or database 84 of the remote server 32 at block 616, and transmits the copy of the data files 62 to the workstation computer 28 at block 618. After the copy of the selected data files 62 has been transmitted to the workstation computer 28, the routine 600 ends at block 620. If, however, the selected one or more data files 62 are not located on the remote server 32, the routine 600 proceeds to block 622, where the user receives an error message that the selected data files 62 are unavailable. The routine 600 then proceeds to add the unavailable data file(s) to a remote list for further procurement at block 624, and ends at block 626.

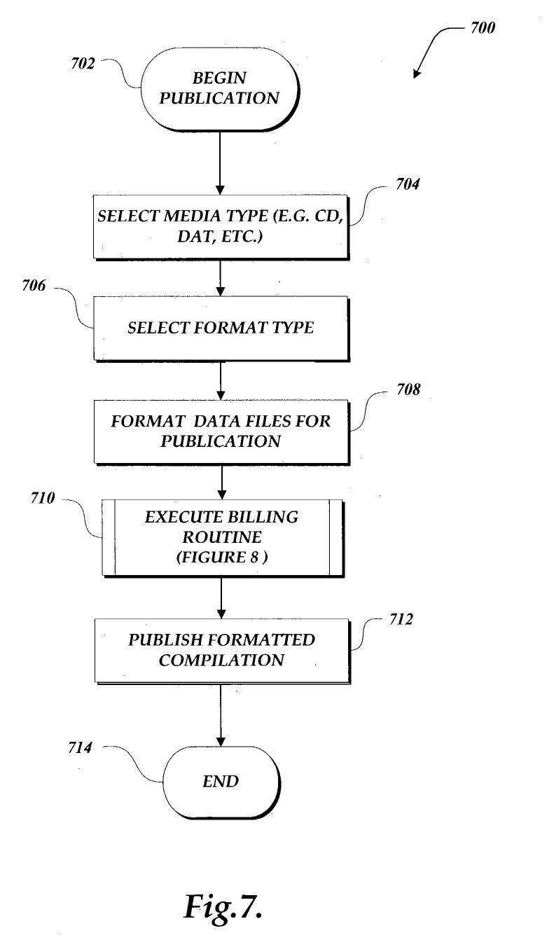

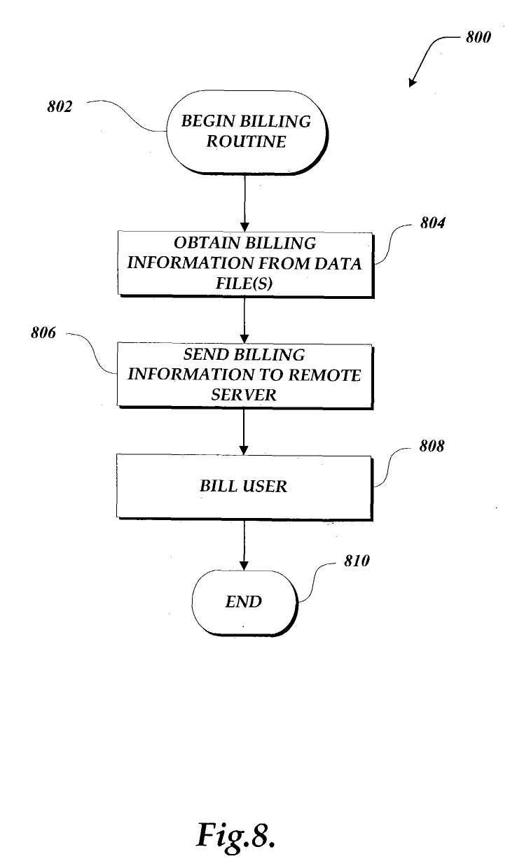

As described briefly above with respect to FIG. 5, FIG. 7 depicts the execution of an illustrative publishing routine 700 in greater detail. The routine 700 begins at block 702 and proceeds to block 704, where the user is prompted to select the type of media for the published compilation. For example, the user is prompted to select media types, such as a compact disc (CD), digital audiotape (DAT), flash memory, or the like. After the user is prompted to select the type of media at block 704, the routine 700 proceeds to block 706, where the user is prompted to select the format type for the compilation. For example, the user may be prompted to select any known compressed or uncompressed data format known in the art. The routine 700 then proceeds to format the selected data files of the type selected at block 708 for publication. Optionally, the routine 700 may proceed to block 710, where a billing routine is executed. As will be described in more detail below with respect to FIG. 8, the billing routine collects royalty data from the data files for future payment to the necessary parties.

The routine 700 then proceeds to block 712, where the selected data files 62 are published for example, by writing the selected data files to the selected media type (e.g. CD, DAT, etc.) by the corresponding output device 68, thereby creating a custom compilation of user selected data files for later use. After the user selected data files 62 are published at block 712, routine 700 ends at block 714. It will be appreciated by those skilled in the art that routine 700 may include other steps, if desired. For example, routine 700 may prompt the user as to whether the user would like a case for the selected media type, or a printed label or other printed text or graphic information associated with the selected data files.

As briefly described above with respect to FIG. 7, FIG. 8 depicts the execution of an illustrative billing routine 600 in greater detail. The routine 800 begins at block 802, and proceeds to block 804, where billing information is obtained from the user selected data files 62. As was described in detail above, specific billing information is associated with each data file for the correct payment of royalties. After the billing information is obtained, the routine proceeds to block 806, where the billing information is transmitted to the central server 32. It will be appreciated that the server application 100 may be configured to contain a program module for the collection and storage of billing information. Optionally, the billing information may be collected locally at the workstation computer 28 by a program module located in the memory of the workstation computer 28. After the billing information is received by either the local or remote server, the routine proceeds to block 808, where the customer is billed based on the billing information obtained from the user selected data files 62. Once the customer (or user) is billed, the routine ends at block 810.

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A method for, creating user selected customized digital data compilations, comprising:
selecting a data file for a custom compilation at a local client associated with a database containing digital data and having an output device;
if the selected data file is available at the database associated with the local client, obtaining a copy of the selected data file from the database;
if the selected data file is not available at the database associated with the local client, obtaining a copy of the selected data file from a remote server associated with a database containing digital data;
creating a compilation list including the obtained data file; and
if the compilation list is complete, publishing the compilation to the local client output device.

2. The method of claim 1, further comprising if the selected data file is not available at the database associated with the remote server, adding the unavailable data file to a list to obtain the file in the future.

3. The method of claim 1, wherein publishing the compilation to the local client output device comprises:
selecting the media type for the publication;
selecting the format type for the publication;
formatting the data file for publication;
executing a billing routine to bill the user for use of the data file; and
publishing the formatted data file in the selected media type.

4. The method of claim 3, wherein executing the billing routine comprises:
sending billing information associated with the data file to the remote server; and
billing the user based on the billing information related to use of the data file.

5. The method of claim 1, wherein the data file includes information billing information related to use of the data file; and further comprising:
obtaining billing information from the data file;
sending billing information to the remote server; and
billing the user based on the billing information related to use of the data file.

6. A system for creating user selected customized digital data compilations, comprising:
a local client associated with a database containing media data, the local client including an input device, and output device and a processor;
a remote server associated with a database containing media data, the remote server coupled to the local client via a network;
wherein the processor of the local client is configured to:
receive a user selection of a data file for a custom compilation at the local client via the local client input device;
if the selected data file is available at the database associated with the local client, obtain a copy of the selected data file from the database;
if the selected data file is not available at the database associated with the local client, obtain a copy of the selected data file from a remote server associated with a database containing digital data;
create a compilation list including the obtained data file; and
if the compilation list is complete, publish the compilation to the local client output device.

7. The system of claim 6, wherein the processor is further configured to:
if the selected data file is not available at the database associated with the remote server, add the unavailable data file to a list to obtain the file in the future.

8. The system of claim 6, wherein the processor is configured to publish the compilation to the local client output device by:
selecting the media type for the publication;
selecting the format type for the publication;
formatting the data file for publication;
executing a billing routine to bill the user for use of the data file; and
publishing the formatted data file in the selected media type.

9. The system of claim 8, wherein the processor is configured to execute the billing routine by:
sending billing information associated with the data file to the remote server; and
billing the user based on the billing information related to use of the data file.

10. The system of claim 6, wherein the data file includes billing-information related to use of the data file; and wherein the processor is further configured to:
obtain billing information from the data file;
send billing information to the remote server; and
bill the user based on the billing information related to use of the data file.

11. A method for creating user selected customized digital data compilations, comprising:
selecting a data file for a custom compilation at a local client associated with a database containing digital data and having an output device, the data file including billing information related to use of the data file;
if the selected data file is available at the database associated with the local client, obtaining a copy of the selected data file from the database;
if the selected data file is not available at the database associated with the local client, obtaining a copy of the selected data file from a remote server associated with a database containing digital data;
creating a compilation list including the obtained data file;
obtaining billing information from the data file;
sending billing information to the remote server;
billing the user based on the billing information related to use of the data file; and
if the compilation list is complete, publishing the compilation to the local client output device.

12. The method of claim 11, further comprising if the selected data file is not available at the database associated with the remote server, adding the unavailable data file to a list to obtain the file in the future.

13. The method of claim 11, wherein publishing the compilation to the local client output device comprises:
selecting the media type for the publication;
selecting the format type for the publication;
formatting the data file for publication;
executing a billing routine to bill the user for use of the data file; and
publishing the formatted data file in the selected media type.

14. The method of claim 13, wherein executing the billing routine comprises:
sending billing information associated with the data file to the remote server; and
billing the user based on the billing information related to use of the data file.
